(19) United States
(12) Patent Application Publication
(10) Pub. No.: US 2006/0150452 A1
(43) Pub. Date: Jul. 13, 2006

(54) Multilayer three-dimensional display

(76) Inventor: Sheng Wu Chen, Chino, CA (US)

Correspondence Address: Julio Loza, Esq.;SHELDON & MAK PC, Suite 900, 225 South Lake Avenue, Pasadena, CA, 91101, US

(21) Appl. No.: 11/303,251

(22) Filed: Dec. 15, 2005

Related U.S. Application Data
(63) Continuation-in-part of application No. 11/088,384, filed on Mar. 23, 2005.

(30) Foreign Application Priority Data
May 31, 2005 (CN) 200520058848.6
Dec. 28, 2004 (CN) 200420103563.5

(51) Int. Cl. G09F 11/18

(52) U.S. Cl. 40/471

(57) ABSTRACT

At least one embodiment of the invention pertains to a display device having a housing, a first panel, a second panel and a light source. The housing, first panel and second panel are positioned substantially coplanar with each other; and the first panel and second panel are positioned at a distance of at least seven millimeters from each other to create a three-dimensional effect of the images displayed on the first and second panels with one or more movable objects contained in the housing unit to create the illusion of motion. According to one embodiment of the invention, the second panel includes an image that defines a frame through which an image on the first panel is visible or perceivable.

### CROSS REFERENCE TO RELATED APPLICATION

This non-provisional United States (U.S.) patent application claims priority from Chinese Patent Application No. 200520058848.6 filed on May 31, 2005, Chinese Patent Application No. 200420103563.5 filed on Dec. 28, 2004, and is a continuation-in-part of U.S. patent application Ser. No. 11/088,384 filed on Mar. 23, 2005, the contents of which are incorporated in this disclosure by reference in their entirety.

### FIELD

Various embodiments of the invention pertain to display devices. At least one embodiment of the invention pertains to an animated display device having multiple display panels arranged to create a three-dimensional illusion.

### BACKGROUND

Display devices are often mounted in offices, shops, and/or homes to enhance the look and/or appearance of an area. Many times, these display devices are decorative items that hang from a wall and display an image, such as a nature scene, an ocean, a lake, a river, a waterfall, a mountain, a beach, and/or a desert. These images are typically printed on a flat display panel and fail to adequately convey a three-dimensional feel or depth to the viewer.

### SUMMARY OF THE INVENTION

One feature of the invention provides a display device having a housing, a first panel and a second panel, all positioned substantially coplanar with each other. The first panel and the second panel are positioned at a distance of at least seven millimeters from each other to create a three-dimensional effect of the images displayed on the first and second panels. According to one embodiment of the invention, the second panel includes an image that defines a frame through which an image on the first panel is visible or perceivable.

One embodiment of the invention provides a display apparatus comprising a housing structure, a light source mounted within the housing structure, a first panel coupled to the housing structure and mounted in front of the light source. The first panel has an image thereon and permits-some light from the light source to pass through. A second panel is coupled to the housing structure and mounted in front of the first panel substantially coplanar with the first panel. The second panel has an image thereon that permits viewing of the image on the first panel. To create a perception of depth and a three-dimensional effect, the first panel and second panel are positioned apart from each other at a distance of at least seven millimeters. The spacing between the first panel and second panel varies depending on the overall size of the display apparatus. Additionally, one or more than one movable objects can be mounted within the housing structure to create a moving effect within the image of the first panel. The image on the second panel can define a frame through which the image on the first panel can be viewed. Additionally, the image on the second panel can include one or more features that contribute to create a three-dimensional effect when overlaid on the image of the first panel. Moreover, features of the image on the second panel can be proportionally larger than features of the image of the first panel to contribute to the illusion of depth between the images.

Another embodiment of the invention provides a decorative display apparatus comprising a housing structure, a first panel coupled to the housing structure and having a first image thereon. A second panel is coupled to the housing structure and mounted in front of the first panel, the second panel mounted substantially coplanar with the first panel. The first panel and second panel are positioned apart from each other at a distance of at least seven millimeters to create a perception of depth when viewing the first image on the first panel. The second panel has a second image thereon that permits viewing of the first image on the first panel.

According to another embodiment of the invention a decorative display apparatus comprises a housing structure, a first panel coupled to the housing structure and having a first image thereon. A second panel is coupled to the housing structure and mounted in front of the first panel, the second panel mounted substantially coplanar with the first panel. The first panel and second panel are positioned apart from each other at a distance of at least seven millimeters to create a perception of depth when viewing the first image on the first panel. Two or more movable objects moving in the same direction can be mounted within the housing structure that can create a moving effect within the image of the first panel. Additionally, in another embodiment of the invention, two or more moveable objects moving in different directions can be mounted within the housing structure that can create a moving effect within the image of the first panel.

In yet another embodiment of the invention the movable objects can be mounted at an angle within the surface plane defined by the first and second panels within the housing structure to create a moving effect within the image of the first panel. For example, movable objects with affixed images can be mounted from corner to corner in an exemplary rectangular shaped display device to give the illusion of the images moving up or down a hillside.

In yet another embodiment, the invention provides that a rolling film with dual-sided images (i.e., an image that is identical on both sides) applied to the rolling film is rotated on a set of rollers such that the rolling film is between the first panel and the second panel. The dual-sided images are rotated around the rollers to create the illusion of motion in a first direction and then in a second direction.

Moreover, another embodiment of the invention provides that the moveable object can be a spinning wheel with images to create a moving effect within the image of the first panel.

According to various other embodiments of the invention, the display apparatus need not be animated to create the same depth effect.

### BRIEF DESCRIPTION OF THE DRAWINGS

FIG. 1 illustrates a display device having a first panel and second panel spaced apart to create a three-dimensional illusion according to one embodiment of the invention.

FIG. 2 illustrates the display device of FIG. 1 with the front panel removed.

FIG. 3 illustrates various components of the lower right corner of the display device according to one embodiment of the invention.

FIG. 4 illustrates the cross-sectional view of the relative position of various components of the display device according to one embodiment of the invention.

FIG. 5 illustrates various components of the lower left corner of the display device according to one embodiment of the invention.

FIG. 6 illustrates various components of the upper left corner of the display device according to one embodiment of the invention.

FIG. 7 illustrates a roller tensioner according to one embodiment of the invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, certain terminology is used to describe certain features of one or more embodiments of the invention. For instance, the terms “display” and “display device” refer to any apparatus or device of any shape or size capable of being hung or supported for displaying one or more images, sceneries, or graphics. The term “panel” (e.g., display panel) includes any substantially flat surface on which one or more images, sceneries, lines, colors, letters, and/or other symbols can be printed or placed. The term “animated” (e.g., animated display) refers to any motion that can be created within a display for the purpose of creating an illusion or effect. The term “image” includes any graphics, lines, colors, letters, and/or other symbols.

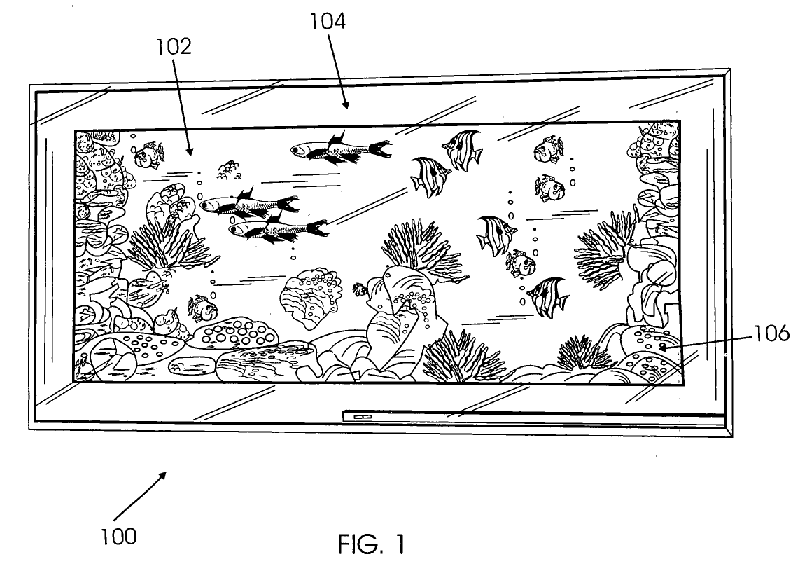

FIG. 1 illustrates a display device 100 having a first panel 102 and second panel 104 spaced apart to create a three-dimensional illusion according to one embodiment of the invention. The display device 100 includes a housing 202, a second panel 104 mounted thereon, and a first panel 102 mounted between the housing 202 and the second panel 104 where the first panel 102 can be perceived through the second panel 104. According to various embodiments of the invention, the second panel 104 can include an image or images to create an aesthetically pleasing view. For example, the image or images can be that of an ocean, an island, a mountain, a lake, a river, a waterfall, a desert, and/or an animal. These images on the first panel 102 and/or second panel 104 can be changeable, so that, for example, the image or images on the second panel 104 can be changed as desired by a user. The images or sceneries on the first panel 102 and/or second panel 104 can be created by using laminates, stickers, painted on the panels, and/or using any other known method. This can be accomplished through changing an image or images laminate or sticker or by replacing one or both of the panels 102 and 104.

According to various embodiments of the invention, the second panel 104 can permit viewing part of the first panel 102 by various means. For example, the second panel 104 can be completely or partially transparent, translucent, or have an opening (i.e., cut-out section) through which the image or images on the first panel 102 can be perceived.

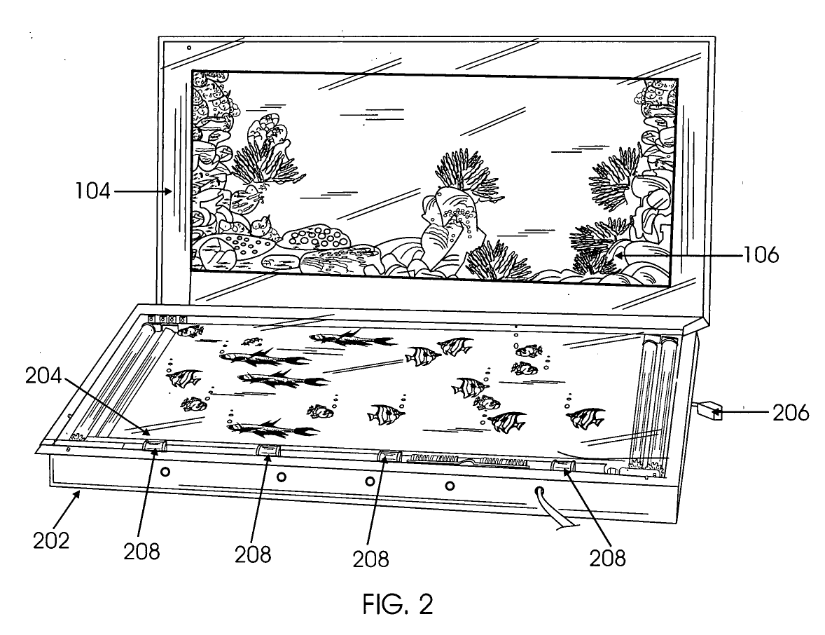

In one embodiment of the invention, the second panel 104 includes a frame 106 through which the image on the first panel 102 is visible or perceivable. For example, the second image on the second panel 104 can define a frame 106 through which the image 204 (FIG. 2) on the first panel 102 is visible. The frame 106 can be in the form of an image, window, door, picture frame, etc., so as to create a three-dimensional illusion that the viewer is actually looking at the image 204 (FIG. 2) on the first panel 102 through said image, window, door, picture frame, etc.

According to one embodiment of the invention the second panel 104 includes an outer border that permits the first panel 102 to be visible. This outer border can include images that create the illusion of three-dimensional effects. For example, the images on frame 106 of the second panel 104 can be proportionately larger than the image(s) or feature(s) 204 (FIG. 2) in the first panel 102 to cause an illusion of depth. Additionally, the images on frame 106 of the second panel 104, e.g., the ocean image illustrated in FIG. 1, can be drawn at an angle to enhance the perception of depth created by positioning the second panel 104 at a distance of at least seven millimeters from the first panel 102.

In various embodiments of the invention, the first panel 102 and the second panel 104 can be substantially flat and mounted coplanar with each other, or one panel can be curved and the other one substantially flat, or both panels can be curved, or the first panel 102 can be mounted at an angle to the second panel 104. In other embodiments of the invention, the first panel 102 and/or second panel 104 may be curved (e.g., not substantially flat) so as to create a depth effect. For instance, the first and second panels 102 and 104 may have a similar curvature, one panel may be curved and the other one substantially flat, or the panels may have opposite curvatures.

One feature of the invention provides a display device having a first panel 102 and a second panel 104, the first panel 102 and second panel 104 are positioned substantially coplanar with each other and at a distance of at least seven millimeters from each other to create a three-dimensional effect of the images displayed on the first panel 102 and second panel 104. According to one embodiment of the invention, the second panel 104 includes an image 106 that defines a frame through which an image on the first panel 102 is visible or perceivable. In alternative embodiments, the second panel 104 can have a cut-out section and/or movable display elements through which image 204 (FIG. 2) on the first panel can be perceived.

FIG. 2 illustrates the display device 100 of FIG. 1 with the second panel 104 removed. The display device 100 includes a housing 202 that serves to support the first panel 102 as well as the second panel 104. The first panel 102 can be secured to the housing 202 using one or more fasteners, braces 208 or other methods as will be understood by those with skill in the art with reference to this disclosure. The second panel 104 can also be secured to the housing 202 using similar fasteners. The first panel 102 and the second panel 104 are mounted to the housing 202 substantially coplanar with each other. The first panel 102 and second panel 104 are spaced apart from each other at a distance of at least seven millimeters determined by the space available for the display 100. It is this separation between the first panel 102 and the second panel 104 that provides a three-dimensional illusion to viewers looking at the images on the first panel 102 through the second panel 104.

According to various embodiments of the invention, the housing 202, display device 100, and/or the first panel 102 and/or the second panel 104 can be of various shapes, including oblong, circular, square, triangular, pentagonal, etc. Additionally, the housing and/or perimeter of the second panel 104 can be made of wood, metal, glass, mirror or other decorative material.

According to one embodiment of the invention, the first panel 102 includes an image or graphic 204 (FIG. 2). The image 204 and/or first panel 102 can be translucent to permit some light to go through the image 204 and/or first panel 102.

Another feature of the invention provides a display control 206 to control the light, and/or motion of the movable objects in the display device 100. Alternatively, various embodiments of the invention can contain multiple controls and/or a single integrated control can be used to perform these functions.

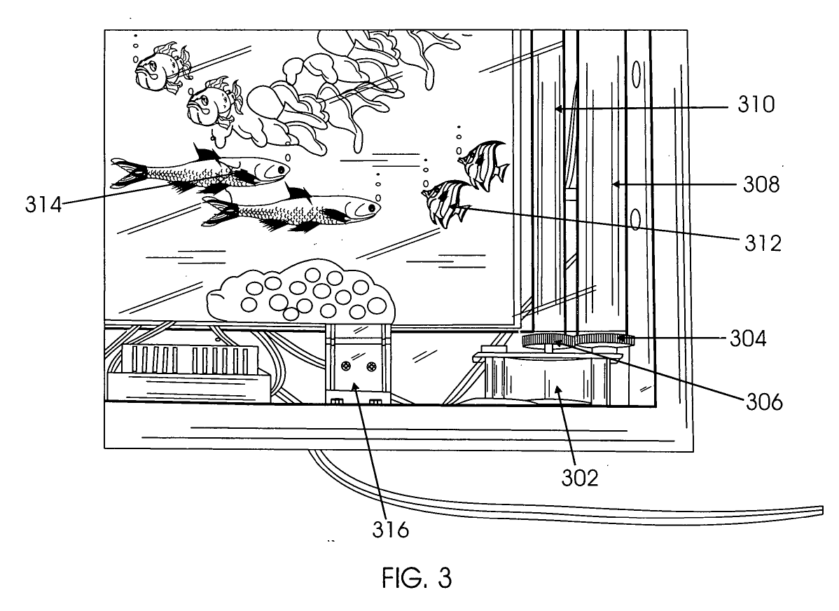

FIG. 3 illustrates various components of the display device 100 according to one embodiment of the invention. The display device 100 can also include one or more components that creates the illusion of motion or movement. In a preferred embodiment, an illusion of aquatic life motion can be created on the ocean image 204 (FIG. 2) coupled to the first panel 102 (FIG. 1). A first translucent moving or rolling display 312 with aquatic life images thereupon, and a second translucent moving or rolling display 314 with aquatic life images thereupon can be placed between the first panel 102 and the second panel 104. The first translucent moving or rolling display 312 and the second translucent moving or rolling display 314 can be positioned across or over the first panel 102 as illustrated in FIG. 3. In an embodiment, motor 302 rotates the first gear 304 and the second gear 306 causing the illusion of movement in the aquatic life images within the display 100 by turning the first roller 308 and the second roller 310 in opposite directions. The first translucent moving or rolling display 312 can be mounted between a first roller 308 and a second roller 310 with the motor 302 coupled to the first gear 304 to cause the first translucent moving or rolling display 312 to rotate. The second translucent moving or rolling display 314 can be mounted between third roller 504 and a fourth roller 506 with the first gear 304 meshed with the second gear 306 to cause the second translucent moving or rolling display 314 to rotate. According to other embodiments of the invention, a rotating disk or other moving object can be used to create the illusion of movement.

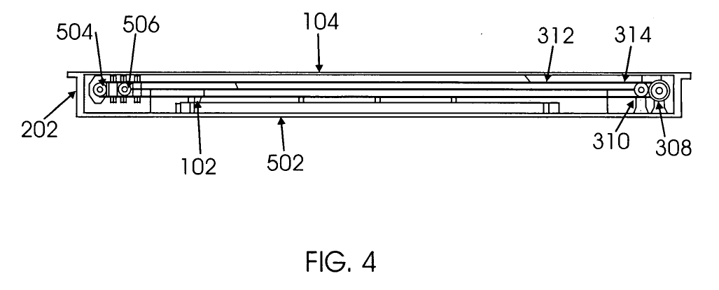

FIG. 4 illustrates a cross-sectional view of a display device according to one embodiment of the invention. One novel aspect of the invention provides for mounting the first panel 102 at a distance of at least seven millimeters from the second panel 104 to create a three-dimensional illusion or effect. According to various embodiments of the invention, the first panel 102 can be mounted at any distance of at least seven millimeters or greater from the inner display panel 104 depending upon the size of the display desired. In a preferred embodiment, the distance between first panel 102 and second panel 104 is at least 13 mm.

FIG. 4 also illustrates the relative position of the various components of the display device 100. The first panel 102 is positioned in between the second panel 104 and the housing 202 with the first translucent moving or rolling display 312 and the second translucent moving or rolling display 314 positioned in between the first panel 102 and the second panel 104. Note that in those embodiments where one or both panels are curved, a sufficient space remains between the panels 102 and 104 to permit the moving or rolling display 312 and the second moving or rolling display to fit in between.

The light source 502 is positioned between the first panel 102 and the housing 202. When illuminated, the light source 502 sends light through the first panel 102, the first translucent moving or rolling display 312, the second translucent moving or rolling display 314, and the second panel 104. Because the first translucent moving or rolling display 312 and the second translucent moving or rolling display 314 are rotating, this causes a moving effect or sensation to be perceivable in the ocean image of the display 100.

FIG. 4 also illustrates the moving display components of display device 100 according to one embodiment of the invention. As previously noted, the first translucent moving or rolling display 312 (e.g., film, etc.) is coupled between the first roller 308 and a second roller 310 and configured to rotate when the motor 302 turns the first gear 304. The second translucent moving or rolling display 314 is coupled between the third roller 504 and the first roller 308 and configured to rotate in the opposite direction when the motor 302 turns the first gear 304 in one direction and the meshed second gear 306 to turn in the opposite direction. An illusion of motion is created on the scene or image of the second panel 104 when the first translucent moving or rolling display 312 and the second translucent moving or rolling display 314 are rotated. Note that in other embodiments of the invention, other moving objects and/or images can be used to create an illusion of movement in an image of the display device.

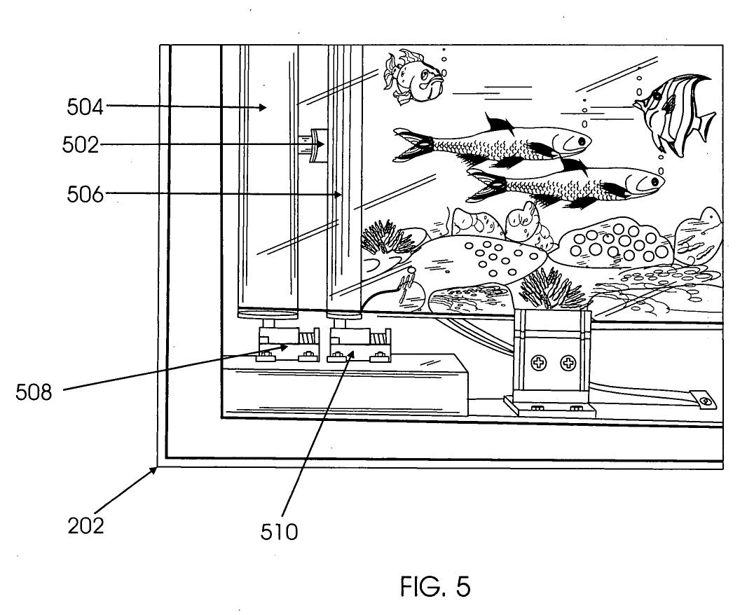

FIG. 5 illustrates various components of the display device 100 according to one embodiment of the invention. Between the housing 202 and the second panel 104, the display device 100 houses a number of components that create a three-dimensional effect and/or make the display device 100 appear animated. A light source 502 can be mounted to the housing 202 using fasteners or braces to secure the light source 502 to the housing 202, as will be understood by those with skill in the art with reference to this disclosure. In a preferred embodiment, the light source 502 is mounted between the first panel 102 and the housing 202 to serve as a backlight such that, when the light source 502 is illuminated, the emitted light is perceivable through the first panel 102 and through the second panel 104. According to one embodiment of the invention the light source 502 can be a fluorescent light.

A third roller 504 works with the first roller 308 to provide a complete rolling path for the first translucent moving or rolling display 312. A fourth roller 506 operates with the second roller 310 to provide a complete rolling path for the second translucent moving or rolling display 314. The third roller 504 is mounted on a first roller tensioner 508 to provide resistance and stability for the first translucent moving or rolling display 312. The fourth roller 506 is mounted on a second roller tensioner 510 to provide resistance and stability for the second translucent moving or rolling display 314. For example, as the first translucent moving or rolling display 312 and the second translucent moving or rolling display 314 rotate, a spring in the roller tensioners 508, 510, 602 and 604 pushes the rollers 502 and 504 away from rollers 308 and 310 in the plane created between the first panel 102 and the second panel 104.

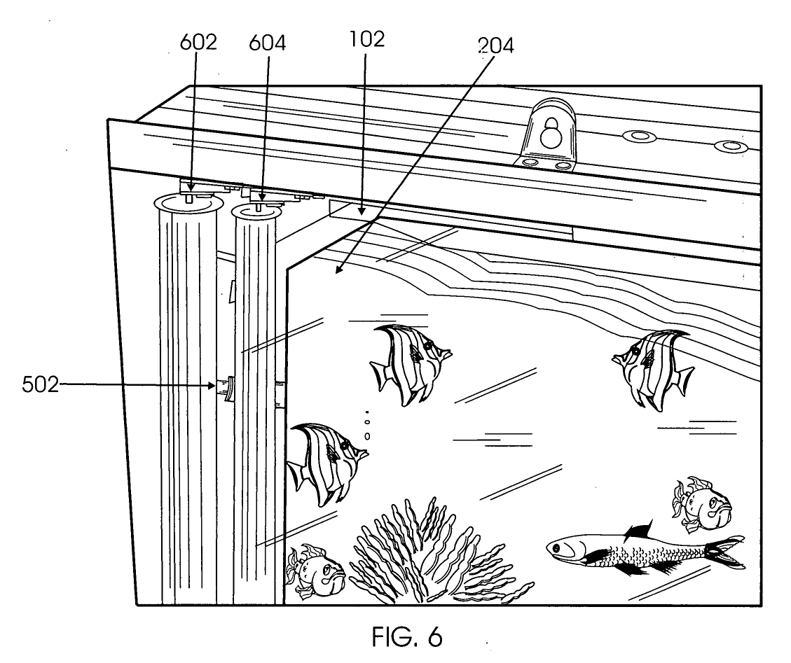

FIG. 6 illustrates various components of the display device 100 according to one embodiment of the invention. A third roller tensioner 602 works with the first roller tensioner 508 to provide stability to the third roller 504. A fourth roller tensioner 604 works with the second roller tensioner 510 to provide stability to the fourth roller 506. The roller tensioners, 508, 510, 602, and 604, also provide the first translucent moving or rolling display 312 and the second translucent moving or rolling display 314 with resistance against the non-tensioned first roller 308 and the second roller 310 to enable motion.

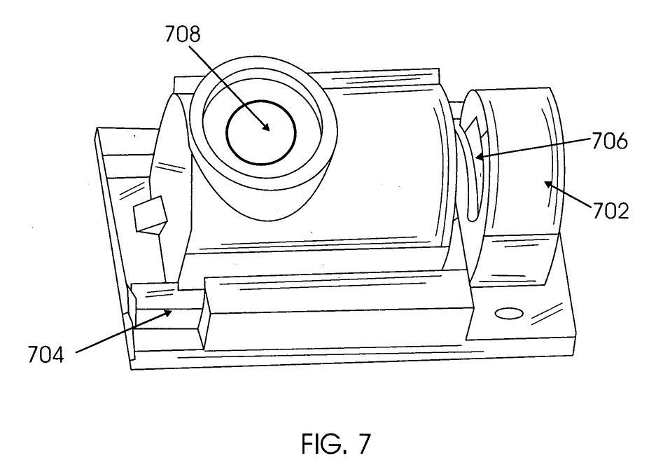

FIG. 7 illustrates a novel roller tensioner. The tensioner includes of a roller tensioner base 702, a roller tensioner slide carriage 704, a roller tensioner spring 706, and a roller sliding mount 708. According to one embodiment of the invention the roller tensioner spring 706 is a push spring that forces the roller tensioner slide carriage 704 outward away from the roller tensioner base 702. In a preferred embodiment, the roller tensioner spring 706 pushes the roller sliding mount 708 from the roller tensioner base 702. In various other embodiments the roller tensioner spring 706 could pull the roller tensioner slide carriage 704 along the roller sliding mount 708 toward the roller tensioner base 702.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled in the art will appreciate that various adaptations and modifications of the just described preferred embodiment can be configured without departing from the scope and spirit of the invention. Therefore, it is to be understood that, within the scope of the appended claims, the invention can be practiced other than as specifically described herein.

What is claimed is:

1. A display apparatus comprising:
a) a display housing;
b) a light source mounted within the housing structure for generating light in a visible spectrum;
c) a first panel coupled to the housing,
the first panel comprises a first panel surface with a first image on the first panel surface;
d) a second panel coupled to the housing,
the second panel comprises a second panel surface with a second image on the second panel surface;
e) one or more movable objects mounted within the housing structure between the first panel and the second panel; and
f) both the first image and the second image are at least partially translucent to light in the visible spectrum, thereby allowing some light in the visible spectrum generated by the light source to pass through the first image and through the second image.

2. The display apparatus of claim 1, wherein the first panel surface and the second panel surface are substantially coplanar to each other.

3. The display apparatus of claim 1, wherein at least one of the first panel surface or the second panel surface is a curved surface.

4. The display apparatus of claim 1, wherein the first panel and the second panel are positioned at a distance of at least seven millimeters from each other to create a perception of depth when the light generated by the light source passes through the first image and through the second image.

5. The display apparatus of claim 1 where the one or more moveable object comprises:
a) one or more rollers;
b) one of either a translucent moving display or a translucent rolling display wound around the one or more rollers;
wherein one of either the one or more translucent moving displays or the translucent rolling display comprises an image;
c) a roller tensioner connected to each of the one or more rollers; and
d) a motor connected to the one or more rollers to cause the one or more rollers to turn, thereby creating motion.

6. The display apparatus of claim 5, where the roller tensioner further comprises:
a) a roller tensioner base mounted on the housing;
b) a roller tensioner slide carriage mounted on the roller tensioner base;
c) a roller tensioner spring connected to the roller tensioner slide carriage; and
d) a roller sliding mount connected to the roller tensioner spring.

7. The display apparatus of claim 1, wherein the one or more movable objects are mounted within the housing structure between the first panel and the second panel; and further comprising a display control for activating the light source and the one or more movable objects to create a moving effect within the image of the first panel.

8. The display apparatus of claim 1, wherein the light source is mounted between the first panel and the housing.

9. The display apparatus of claim 1, wherein the second image defines a frame around the first image.

10. The display apparatus of claim 1, wherein the second image is proportionally larger than the first image.

11. The display apparatus of claim 1, further comprising: a third panel with a third image that is different from the first image, and where the third panel is configured to be interchangeable with the first panel.

12. The display apparatus of claim 1, further comprising a fourth panel with a fourth image that is different from the second image, and where the fourth panel is configured to be interchangeable with the second panel.

13. A decorative display apparatus comprising:
a) a housing structure;
b) a first panel coupled to the housing structure and having a first image;
c) a second panel coupled to the housing structure and mounted in front of the first panel, the second panel mounted substantially coplanar with the first panel, the first panel and second panel positioned apart from each other at a distance of at least seven millimeters to create a perception of depth when viewing the first image on the first panel, the second panel having a second image thereon that allows viewing of the first image on the first panel, the second image including an image to enhance the perception of depth of the first image;
d) a first rolling film mounted within the housing structure that can be activated to move and create a moving effect within the first image of the first panel; and
e) a second rolling film mounted within the housing structure that can be activated to move and create a moving effect within the first image of the first panel.

14. The decorative display apparatus of claim 13 wherein features of the second image on the second panel are proportionally larger than features of the first image of the first panel to create an illusion of depth between the images.

15. The decorative display apparatus of claim 13 wherein the first rolling film and the second rolling film move in the same direction.

16. The decorative display apparatus of claim 13 wherein the first rolling film and the second rolling film move in opposite directions.

17. The decorative display apparatus of claim 13 wherein the first rolling film and the second rolling film move at the different speeds.

18. A method for creating a three-dimensional effect on a display panel, comprising:
a) creating a first image on a first panel;
b) creating a second image on a second panel;
c) positioning the first panel in front of, and substantially coplanar with, the second panel, the first image on the first panel permitting viewing of the second image on the second panel, the first panel and second panel positioned apart from each other at a distance of at least seven millimeters to create a perception of depth when viewing the second image on the second panel; and
d) positioning a first movable surface and a second movable surface arranged behind the second panel.

19. The method of claim 18 wherein the first image and the second image are replaceable with other images as desired.

20. The method of claim 18 further comprising:
scaling the features of the first image on the first panel proportionally larger than features of the second image on the second panel to create an illusion of depth between the images.
